(19) United States
(12) Patent Application Publication
(10) Pub. No.: US 2012/0239215 A1
(43) Pub. Date: Sep. 20, 2012

(54) METHOD AND APPARATUS FOR DETECTING ISLANDING CONDITIONS OF DISTRIBUTED GENERATOR

(75) Inventors: Adrian Timbus, Daettwil (CH); Alexandre Oudalov, Fislisbach (CH); Gerardo Escobar, Dattwil-Baden AG (CH); Leonardo-Augusto Serpa, Zurich (CH)

(73) Assignee: ABB RESEARCH LTD, Zurich (CH)

(21) Appl. No.: 13/419,645

(22) Filed: Mar. 14, 2012

(30) Foreign Application Priority Data
Mar. 14, 2011 (EP) 11158034.6

(51) Int. Cl. G06F 1/28

(52) U.S. Cl. 700/292

(57) ABSTRACT

A method and apparatus are provided for detecting islanding conditions for distributed generators connected to a grid. The method includes estimating a grid impedance, and inducing, on the basis of the estimated grid impedance, a variation on a value of a first electrical quantity of the grid. The method also includes monitoring a grid response to the variations, and determining islanding conditions on the basis of the monitored response.

### RELATED APPLICATION

This application claims priority under 35 U.S.C. §119 to European Patent Application No. 11158034.6 filed in Europe on Mar. 14, 2011, the entire content of which is hereby incorporated by reference in its entirety.

### FIELD

The present disclosure relates to distributed power generation, and more particularly, to a method and apparatus for detecting islanding conditions for distributed generators.

### BACKGROUND INFORMATION

Distributed generation (DG) based on renewable energy resources has shown a significant growth facilitated by policy makers, global concerns about climate change, the availability of affordable energy shortage technologies, interest in clean energy production, etc. Energy suppliers using power plants based on fossil fuel (coal, natural gas, etc.) are also investing in an extension of energy generation portfolios by renewable alternatives such as wind turbines and photovoltaic systems.

However, for connecting such systems to the utility grid, several requirements are to be met. In case of photovoltaic systems (PV), these requirements are typically published by standardizing institutions, such as the International Electrotechnical Commission (IEC) and Institute of Electrical and Electronics Engineers (IEEE), but also by local regulating authorities. One of the requirements, which is mandatory in many parts of the world, is that photovoltaic systems should be able to detect islanding conditions.

Islanding refers to a condition of a distributed generator continuing to power a part of a distribution network even though power from an electric utility is no longer present. FIGS. 1a and 1b show a difference between a grid-connected mode and an islanding mode. In FIG. 1a, a switching device 1 (e.g., a circuit breaker or fuse) is closed, and distributed generators operate in a grid-connected mode. In FIG. 1b, the switching device 1 is opened and the lower part 2 of the network is no longer connected to the main grid. However, if the power generated by distributed generators closely matches the power required by the load, the network can continue operation in an islanding mode.

Islanding can be dangerous to utility workers, who may not realize that the particular part of the network is still powered even though there is no power from the main grid. Also, islanding can lead to damages to customer equipment, especially in situations of re-closing into an island. For that reason, distributed generators may have to be able to detect islanding and immediately stop power production.

Historically many methods for detecting islanding conditions have been developed. These methods can be categorized in three main groups: passive, active, and communication-based methods.

Passive methods monitor one or more grid variables and, based on deviation of the variables from allowed thresholds, a decision of disconnecting (detection of islanding) can be made.

Active methods deliberately disturb the grid and, on the basis of the grid response to that disturbance (e.g., variation of grid electrical quantities), decide whether or not islanding occurred.

Communication-based methods make use of a communication means with an external unit (owned, for instance, by the distribution system operator) which signal the opening of the switching equipment to all distributed generators in that part of the network.

Each of the above methods has its own strengths and weaknesses. Active methods are the most frequently encountered in today's market. An advantage of the active methods is a very small non-detection zone and ease of implementation in a microprocessor. However, active methods may have a disadvantage due to the disturbances they introduce into the grid, disturbances which are often associated with power quality. In some cases, large current variations produced for observing the islanding detection may have a negative influence on the power quality.

The variations may be empirically selected in order to ensure that the distributed generator does not miss islanding conditions. The variation may be chosen to be higher than necessary just to provide a safety margin. The maximum variation may be limited by the regulating authorities.

While current variations produced by distributed generators are fixed for a certain manufacturer, a grid response to these variations is dependent on the grid impedance seen by the distributed generator. Consequently, the grid response is different for different impedances (or different locations). Therefore, the disturbances created by the active methods may not be optimal for all locations and operating conditions.

### SUMMARY

An exemplary embodiment of the present disclosure provides method for detecting islanding conditions for a distributed generator connected to a grid. The exemplary method includes estimating a grid impedance, and inducing a variation on a value of a first electrical quantity of the grid. The exemplary method also includes optimizing a magnitude of the induced variation on the basis of the estimated grid impedance to minimize an impact of the induced variation on the grid. In addition, the exemplary method includes monitoring a grid response to the variation, and determining islanding conditions on the basis of the monitored response.

An exemplary embodiment of the present disclosure provides an apparatus for detecting islanding conditions of a distributed generator connected to a grid. The exemplary apparatus includes means for estimating a grid impedance, and means for inducing a variation on a value of a first electrical quantity of the grid. The exemplary apparatus also includes means for optimizing a magnitude of the induced variation on the basis of the estimated grid impedance to minimize an impact of the induced variation on the grid. In addition, the exemplary apparatus includes means for monitoring a grid response to the variation, and means for determining islanding conditions on the basis of the monitored response.

An exemplary embodiment of the present disclosure provides a non-transitory computer-readable recording medium having a computer program recorded thereon that causes a processor of a computer processing device to detect islanding conditions for a distributed generator connected to a grid. The pro-gram causes the processor to execute operations including: estimating a grid impedance; inducing a variation on a value of a first electrical quantity of the grid; optimizing a magnitude of the induced variation on the basis of the estimated grid impedance to minimize an impact of the induced variation on the grid; monitoring a grid response to the variation; and determining islanding conditions on the basis of the monitored response.

### BRIEF DESCRIPTION OF THE DRAWINGS

Additional refinements, advantages and features of the present disclosure are described in more detail below with reference to exemplary embodiments illustrated in the drawings, in which:

FIGS. 1a and 1b illustrate a main difference between a grid connected mode and an islanding mode of a distributed network;

FIG. 2 illustrates a relationship between voltage, impedance and current according to an exemplary embodiment of the present disclosure;

FIG. 3 illustrates an exemplary embodiment of the present disclosure in which a distributed generator is connected to a utility grid; and

FIG. 4 illustrates an exemplary embodiment of the present disclosure in which a value of grid impedance is used to calculate the right variation necessary to be injected to a grid connection point in order to detect islanding.

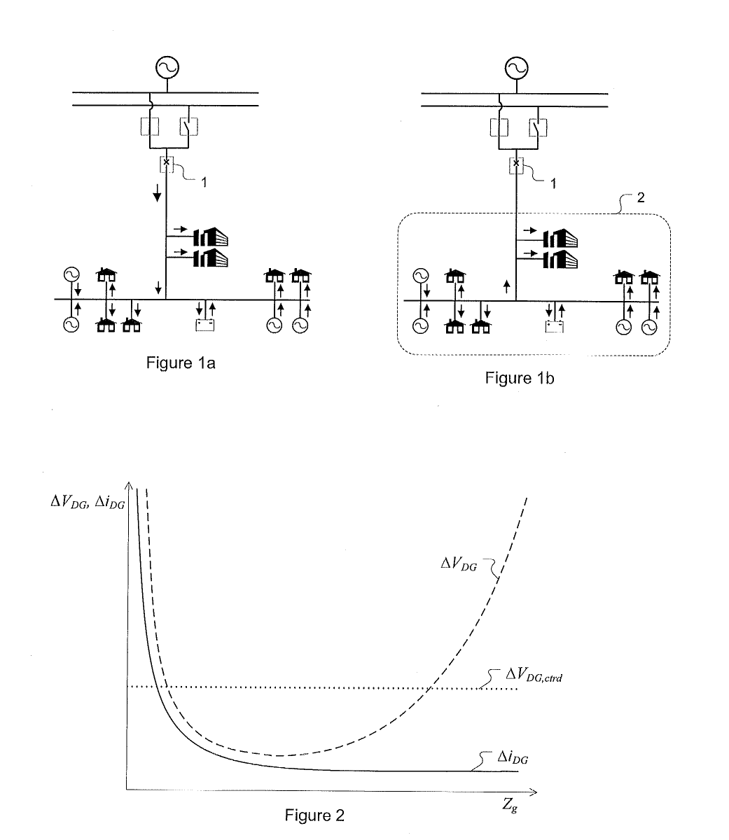

### DETAILED DESCRIPTION

Exemplary embodiments of the present disclosure provide a method and an apparatus for detecting islanding conditions for a distributed generator connected to a grid. The method and apparatus of the present disclosure overcome the above problems. For instance, the exemplary method includes estimating a grid impedance, and inducing a variation on a value of a first electrical quantity of the grid. A magnitude of the induced variation is optimized on the basis of the estimated grid impedance to minimize an impact of the induced variation on the grid. The exemplary method also includes monitoring a grid response to the variation, and determining islanding conditions on the basis of the monitored response. The exemplary apparatus of the present disclosure implements the above-described method. Additional features of the exemplary embodiments of the present disclosure are described in more detail below with reference to the drawings.

Exemplary embodiments of the present disclosure are based on the idea of adaptive self adjustment of the variations induced to the grid for different values of grid impedances. The variations may be adjusted on the basis of an estimated grid impedance. A threshold value to which a grid response is compared may also be adjusted.

The disclosed adaptive adjustment for different values of grid impedance can help diminish an impact on power quality caused by potentially large power variations. An impact on other distributed generators connected to the same feeder may also diminish, thus minimizing the risk of exceeding their nuisance trip limits (for example, a limit at which a small disturbance in the network, such as connection/disconnection of a load, causes a fault event on the distributed generator) due to potentially large grid voltage variations.

As an example, a grid response in terms of voltage variations is detailed below. FIG. 2 illustrates a relationship between voltage variation ΔV_{DG}, grid impedance Z_{g} and an output current variation Δi_{DG}. The output current variation Δi_{DG} of a distributed generator is represented by a solid line. The voltage variation ΔV_{DG} at the output of the distributed generator is represented by a dashed line.

Because of a direct relationship between these quantities, two situations can be found where the voltage variation gets a large magnitude. If the current variation Δi_{DG} is large, the voltage variation ΔV_{DG} is large. Similarly, if grid impedance Z_{g} is large, the voltage variation ΔV_{DG} is large.

If grid impedance Z_{g} is known, one can control the current variation Δi_{DG} in such a way that a voltage drop over that impedance Z_{g} is constant and controllable over time. A controlled voltage variation ΔV_{DG,ctrd} is represented as a dotted line in FIG. 2. The voltage variation can be controlled to be as large as necessary above the threshold but not too large.

Therefore, according to an exemplary embodiment, the following method for detecting islanding conditions may be used. First, grid impedance is estimated. To achieve this, monitoring of grid parameters such as voltage, frequency or current may be necessary. A variation may then be induced on a first electrical quantity of the grid. In order to minimize an impact of the induced variance on the grid, a magnitude of the induced variation may be optimized on the grid on the basis of the estimated grid impedance. The first electrical quantity may, for instance, be the output current of the distributed generator. The variation may, for instance, be induced by determining a variation reference on the basis of the estimated impedance, and by controlling the distributed generator, on the basis of the variation reference, to induce the variation on the first electrical quantity.

As the variations of the first electrical quantity cause variations to a second electrical quantity of the grid, a grid response, in the form of the variations of the second electrical quantity, may then be monitored. The islanding conditions may be determined on the basis of the monitored response. The second electrical quantity may, for instance, be a voltage, frequency or phase of the grid at a connection point of the distributed generator. The variation of a second electrical quantity is determined to estimate the grid impedance.

Then, the variation of the second electrical quantity may be compared with a set threshold. The islanding conditions may then be determined on the basis of the comparison. The threshold does not have to be fixed. A level for the threshold may, for instance, be determined on the basis of a steady state grid response in grid-connected mode.

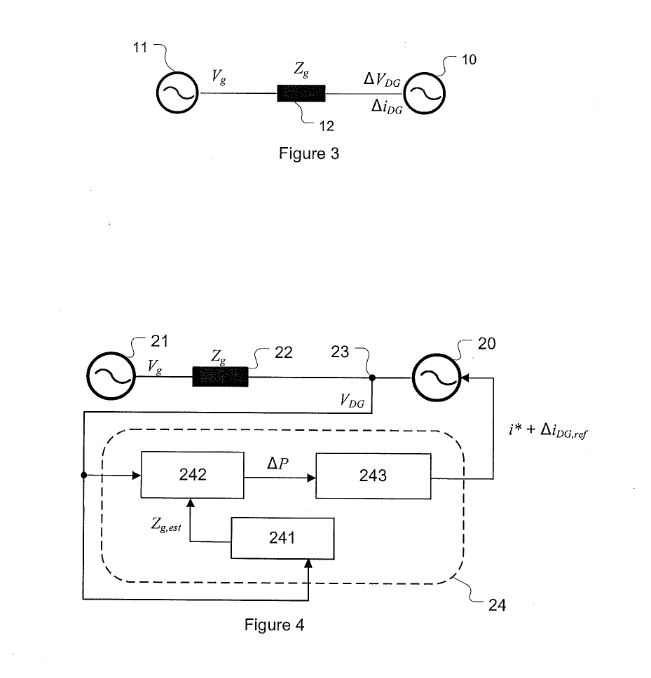

FIG. 3 illustrates an exemplary embodiment of the present disclosure in which a distributed generator 10 is connected to a utility grid 11. An impedance 12 is between the generator 10 and the grid 11. The generator controls a current i_{dg} at a grid connection point. An active component and a reactive component of the current i_{DG} may be represented as follows:

ip_{DG}(t)=iP_{DG}(t−1)+Δip_{DG}(t) (1)

iq_{DG}(t)=iq_{DG}(t−1)+Δiq_{DG}(t) (2)

where ip_{DG}(t) is the active current delivered by generator at a time instant t,ip_{DG}(t−1) is the active current delivered by the generator at the time instant t−1, and Δip_{DG}(t) is the current variations between time instant t−1 and t. Similar notations apply also to a reactive current iq_{DG}.

Variations in active and reactive currents lead to voltage ΔV_{DG} and/or frequency Δf_{DG} variations at the grid connection point, depending on the type of impedance the grid has. In case the utility grid is present (grid-connected mode), the variations may be very small due to voltage and/or frequency controls on the side of the utility grid. However, in a situation where the grid source is disconnected (islanding mode), these variations will increase and, on the basis of the level of increase, islanding occurrence can be assessed.

The exemplary method of the present disclosure may be used in the embodiment of FIG. 3. An estimate of the grid impedance may be calculated, for instance, by monitoring the changes Δi_{DG} of the generated current vector and changes ΔV_{DG} of grid voltage vector:

V_{DG}(t−1)=V_{g}(t−1)−Z_{g}i_{DG}(t−1) (3)

V_{DG}(t)=V_{g}(t)−Z_{g}i_{DG}(t) (4)

Assuming that the grid voltage V_{g} does not change significantly, an estimate Z_{g,est} of the grid impedance may be calculated as follows:

$${Z}_{g , est} = \frac{Δ {V}_{DG}}{Δ {i}_{DG}} \qquad ( 5 )$$

The current variation Δi_{DG} created by the DG leads to voltage variation ΔV_{DG} at the DG terminals. ΔV_{DG} is then compared with a threshold value Vₜᵣₛₕ, and if its value is larger than the threshold, islanding conditions are considered. Since the variations of voltage at DG terminals need to be larger than the threshold voltage, e.g., ΔV_{DG}>Vₜᵣₛₕ, knowing the value of Z_{g,est}, the current variations can be derived with regard to Vₜᵣₛₕ as:

$$Δ {i}_{DG} > \frac{{V}_{trsh}}{{Z}_{g}} \qquad ( 6 )$$

FIG. 4 illustrates another exemplary embodiment in which a value of grid impedance is used to calculate the right variation necessary to be injected to a grid connection point in order to detect islanding. A distributed generator 20 is connected to a utility grid 21. An impedance 22 is between the generator 20 and the grid 21. The generator 20 controls a current i_{DG} at a grid connection point 23. The exemplary embodiment includes an apparatus 24 for detecting islanding conditions of the distributed generator 20. The apparatus 24 controls the generator 20. The apparatus 24 includes an impedance calculation block 241, an islanding detection block 242, and a generator controller 243. The generator controller 243 may, as in the embodiment of FIG. 4, give an output current reference i* to the generator 20. The generator 20 then produces the output current on the basis of the reference.

On the basis of a voltage measurement at a point of connection 23 with the utility grid, an estimate Z_{g,est} of a grid impedance is first calculated in the impedance calculation block 241. The calculation may be done, for instance, using the algorithm described by equations 3 to 5.

The estimated impedance Z_{g,est} is then passed to an islanding detection block 242 which adapts an output power variation in such a way that the variations created in the grid are sufficiently high to determine islanding conditions. The islanding detection block 242 may, for instance, calculate a value for a variation reference parameter ΔP on the basis of the estimated impedance Z_{g,est}. The generator controller 243 may then control the output of the distributed generator 20, on the basis of the variation reference ΔP, to induce variations in the grid. The controller 243 may, for instance, modify the current reference i* to contain a variation Δi_{DG,ref}, which, in turn, induces variation Δi_{DG} in the output current.

On the basis of the grid response to the variations, the islanding condition may be assessed. The islanding detection block 242 determines the islanding conditions, for instance, by monitoring the voltage variations. The amount of increase in the induced variations is compared to a threshold and if it exceeds the threshold value, islanding is assumed. The grid response may also be monitored in other quantities, for instance frequency or phase quantities.

If an islanding condition is assumed, a decision of disconnecting the distributed generator 20 from the grid may be made. The level of the threshold may also be determined on the basis of the estimated grid impedance, for instance as in equation 6.

Impedances between a grid and a distributed generator may be different for different arrangements. However, impedance between a grid and a distributed generator in one arrangement typically stays constant. By observing a steady state grid response in a grid-connected mode, the threshold can be lowered closer to the nuisance trip limit, thus permitting to lower the grid variations even more. Another aspect of lowering the threshold is that by lowering the threshold value as close as possible to the limit where nuisance trip in grid-connected mode may happen, a higher sensitivity of the method in the islanded mode may be achieved.

The impedance calculation block 241, islanding detection block 242, and generator controller 243 are illustrated as functional blocks in the exemplary embodiment illustrated in FIG. 4. The blocks 241-243 may be implemented as one or more processors of a computer processing device executing one or more computer programs tangibly recorded on a non-transitory computer-readable recording medium (e.g., a non-volatile memory). The blocks 241-243 may also be implemented as digital processing circuitry, analog processing circuitry, or any combination thereof.

It will be obvious to a person skilled in the art that, as the technology advances, the inventive concept can be implemented in various ways. The invention and its embodiments are not limited to the examples described above but may vary within the scope of the claims.

Thus, It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for detecting islanding conditions for a distributed generator connected to a grid, the method comprising:
estimating a grid impedance;
inducing a variation on a value of a first electrical quantity of the grid;
optimizing a magnitude of the induced variation on the basis of the estimated grid impedance to minimize an impact of the induced variation on the grid;
monitoring a grid response to the variation; and
determining islanding conditions on the basis of the monitored response.

2. A method according to claim 1, wherein the inducing of the variation on the grid comprises:
determining a variation reference on the basis of the estimated impedance; and
controlling the distributed generator on the basis of the variations reference to induce a variation on the first electrical quantity.

3. A method according to claim 1, wherein the monitoring of the grid response comprises:
determining a variation in a second electrical quantity of the grid induced by the variations of the first electrical quantity;
comparing the variation in the second electrical quantity with a set threshold; and
determining whether to disconnect the generator on the basis of the comparison.

4. A method according to claim 1, wherein the comparing of the determined quantity with the set threshold comprises:
determining a level for the threshold on the basis of a steady grid response in a grid connected mode.

5. A method according to claim 2, wherein the monitoring of the grid response comprises:
determining a variation in a second electrical quantity of the grid induced by the variations of the first electrical quantity;
comparing the variation in the second electrical quantity with a set threshold; and
determining whether to disconnect the generator on the basis of the comparison.

6. A method according to claim 5, wherein the comparing of the determined quantity with the set threshold comprises:
determining a level for the threshold on the basis of a steady grid response in a grid connected mode.

7. A method according to claim 5, wherein the second electrical quality of the grid includes at least one of a voltage, frequency and phase of the grid.

8. A method according to claim 3, wherein the second electrical quality of the grid includes at least one of a voltage, frequency and phase of the grid.

9. An apparatus for detecting islanding conditions of a distributed generator connected to a grid, the apparatus comprising:
means for estimating a grid impedance;
means for inducing a variation on a value of a first electrical quantity of the grid;
means for optimizing a magnitude of the induced variation on the basis of the estimated grid impedance to minimize an impact of the induced variation on the grid;
means for monitoring a grid response to the variation; and
means for determining islanding conditions on the basis of the monitored response.

10. A non-transitory computer-readable recording medium having a computer program recorded thereon that causes a processor of a computer processing device to detect islanding conditions for a distributed generator connected to a grid, the program causing the processor to execute operations comprising:
estimating a grid impedance;
inducing a variation on a value of a first electrical quantity of the grid;
optimizing a magnitude of the induced variation on the basis of the estimated grid impedance to minimize an impact of the induced variation on the grid;
monitoring a grid response to the variation; and
determining islanding conditions on the basis of the monitored response.
